(19) United States
(12) Patent Application Publication
(10) Pub. No.: US 2015/0158742 A1
(43) Pub. Date: Jun. 11, 2015

(54) DE-WATERING

(71) Applicant: DESIGN TECHNOLOGY & INNOVATION LTD, London (GB)

(72) Inventor: Mark Christopher Tonkin, Sussex (GB)

(73) Assignee: DESIGN TECHNOLOGY & INNOVATION LTD, London (GB)

(21) Appl. No.: 14/399,886

(22) PCT Filed: May 8, 2013
(86) PCT No.: PCT/GB2013/051193

§ 371 Date: Nov. 7, 2014

(30) Foreign Application Priority Data
May 8, 2012 (GB) 1208030.5

(51) Int. Cl. C02F 1/44; C10L 5/46; C10L 9/00; C10L 5/42

(52) U.S. Cl. CPC C02F 1/44; C10L 5/42; C10L 5/46; C10L 9/00; C02F 2303/04; C02F 2103/20

(57) ABSTRACT

A material is dewatered by providing a material having a first water percentage content; and encapsulating the material in a plurality of non-porous hydrophilic membranes, said membranes being of a type in which water molecules are absorbed by and transported across the non-porous hydrophilic membrane, thereby producing packages with a second water percentage content that is lower than the first water percentage content.

This invention relates generally to the dewatering or concentration of hydrated materials.

The Applicant has recognised that there is a great need, in many different fields, to remove water from materials. This might be to permit easier handling or allow different processing of the dehydrated material, or to utilise the recovered water, or both.

When viewed from a first aspect the invention provides a method of dewatering a material comprising:
providing a material having a first water percentage content;
encapsulating the material in a plurality of non-porous hydrophilic membranes, said membranes being of a type in which water molecules are absorbed by and transported across the non-porous hydrophilic membrane, thereby producing packages with a second water percentage content that is lower than the first water percentage content.

Thus it will be seen by those skilled in the art that in accordance with the invention material can be dewatered by placing it in packages formed by suitable membranes. By encapsulating the material in a plurality of individual packages, the contact area between the material and the membrane may be significantly greater than if the material were in a bulk against the membrane. Those skilled in the art will appreciate the high level of investment currently made in facilities which can provide dewatering of materials and can therefore appreciate the enormous potential of the more straightforward solution provided in accordance with embodiments of the present invention.

As foreshadowed earlier, there are many possible fields in which the present invention could be implemented. For example the hydrated material could comprise milk which is concentrated by the process or other foodstuffs which are dehydrated.

The material could comprise water containing dissolved and/or suspended pollutants so that the water removed is the desired end product rather than the dewatered contents of the package (although that too may be commercially valuable). For example the method could be used to desalinate, decontaminate or disinfect water since the membrane used in accordance with at least preferred embodiments of the invention is capable of retaining microbes, viruses and bacteria that are present in water whilst purified water is absorbed by and passes across the membrane. Embodiments of the invention facilitate the cost-effective separation of water from something, making it cheaper/easier to transport or easier to recover valuable elements or more commercially viable, whilst also allowing the purified water recovered from the de-watering process to be used for any useful purpose.

In an advantageous set of embodiments the method according to the invention is used to dewater a material to make it suitable, or more suitable, for use as a fuel.

It is recognised in the field of energy generation that the increasing energy demands of the world population are becoming more difficult to meet, especially in view of the diminishing supply of fossil fuels. In addition to the problem of the limited supply of fossil fuels such as coal and oil, these fuels are known to have the further problem that the by-products of their combustion contain pollutants that are damaging to the environment, for example contributing to global warming.

Alternative sources have other associated problems, for example the hazardous waste materials from nuclear power generation are difficult to dispose of, and renewable sources such as wind, solar and hydroelectric energy are relatively inefficient, unreliable and location-dependent.

There have in recent times been efforts to utilise plants grown specifically for the production of fuel, so-called biofuels, to meet the increasing energy demands, but these have proved difficult to exploit economically and give rise to concerns in relation to the exploitation of resources as an alternative to food production.

Methods in accordance with the invention which provide automatic dewatering of the original material can make the material into a fuel accessible for exploitation in energy production. This significantly opens up the range of materials which can be exploited as fuels in spite of having what would otherwise have been a prohibitively high water content. For example in one set of embodiments the material comprises woodchips or sawmill dust. Normally this is considered a waste product and may be used for low-grade manufactured materials and is not suitable for use a fuel in view of its water content. However in accordance with embodiments of the invention it can be safely and conveniently dewatered and thus rendered suitable for gasification.

In a particularly advantageous set of embodiments the material comprises human or animal waste, e.g. slurry or sewage. Slurry for example is a very particular problem, particularly on intensive dairy and beef cattle farms: each cow produces a large amount of slurry - typically around eighty litres a day. When it is wet, the slurry can only be returned to the land at certain times of year by law (in some countries) when rain is unlikely to wash the waste into watercourses. The problem is compounded by the fact that however In some places it is required by law to spread the slurry back to the land to retain the nutrients, particularly nitrogen phosphates and potassium, NPK. If this can only be done at certain times of year and the slurry must be stored through the rest of the year. Storage in slurry ponds is dangerous and unpleasant, dangerous for people and dangerous for the environment. However by dewatering it in accordance with the invention, the window for spreading it back to land is hugely increased and so the storage problem is significantly reduced.

As well as providing valuable fuel and reducing the problems associated with disposing of a waste product, dewatering slurry in accordance with the invention can also produce fresh water which can be returned to farms for irrigation or communities for other re-use. Water can be infinitely recycled, there is a huge financial and environmental benefit from recovering the water from slurry, anaerobic digestion digestate, sewage and so on.

Similar considerations apply to the dewatering of sewage—either raw or in the form of digestate from aneroid bacterial digestion. The ability to reduce the amount of raw sewage pumped into the sea has significant environmental implications. By dewatering in accordance with the invention it becomes possible and practical to make fertiliser or gasify the remainder of the waste—not just eliminating the environmental damage of disposing of waste directly into the oceans but converting the ‘waste’ stream into a valuable resource. Moreover the gasification process does not necessarily destroy phosphates and they can be recovered before, during or after the gasification process. This is particularly important as the world is running out of phosphates, critical to the growing of plants. Retaining phosphates in the packages and recovering them is a huge advantage over them being pumped into the sea.

It will be appreciated therefore that in a set of embodiments the method comprises the step of gasifying the packages once the second water percentage content has been achieved. The gasification could be used directly to generate electrical power and/or may comprise producing a different synthesised gas (syngas) which can be used for example in the production of another liquid or gaseous fuel.

Although some non-limiting examples of suitable materials that may be used in embodiments of the present invention have been mentioned, there are many other possibilities. For example embodiments of the method may be used to create a fuel material from virtually any carbon-based waste material or liquid.

Once dewatered in accordance with the embodiments of the invention set out above, the packages can become useful fuel in their own right. When viewed from a second aspect therefore the invention provides a fuel package comprising a fuel mixture encapsulated in a non-porous hydrophilic membrane.

In some embodiments, the material is homogenized, but this is not essential.

A specific application which has been mentioned above is the dewatering of woodchips and sawmill dust prior to gasification. This process illustrates the further and wide-ranging benefits achievable in accordance with embodiments of the invention since the Applicant has recognised that even when woodchips have been dewatered in accordance with the invention, when gasifying wood chips, even a relatively small gasifier will produce as much as 50 L/hour of heavily polluted water. However in an embodiment of the invention further packages can be filled with this water and then the water leaving the packages will be purified with the pollutants retained inside. These packages can be returned to the gasifier so that a very high proportion of the pollutants are converted into syngas. The water can either be allowed to escape as vapour into the atmosphere or retained for use as purified water.

In preferred embodiments encapsulating the mixture in the membrane substantially reduces the water percentage content (which may be measured by weight, by volume or by any other convenient measure). For example, the reduction in water percentage content may be greater than 50%, greater than 70%, greater than 90% or greater than 95%. In one illustrative example the water content of anaerobic sewage digestate waste streams is typically between 55 and 97% but the water content of liquid to be dehydrated can be anything up to 99.9%. The second water content of the packages can be set for the desired post-dewatering percentage right down to less than 1%. The figures given here should be taken merely as examples and not limiting; the actual values will depend on the particular application.

The provision of a non-porous hydrophilic membrane to encapsulate the material allows the packages to be produced in a variety of shapes and sizes to suit the particular application. The optimum shape of the packages may depend on their contents. For example if the material is semi-solid it might conveniently be extruded to fill successively defined sections of a continuous tube of the membrane material in the manner of sausages. In a set of embodiments the packages comprise pouches formed by planar sections of the membrane material sealed at their edges.

In some applications, relatively small packages are preferred as they give a higher ratio of surface area to volume thereby permitting rapid and effective dehydration and, for example, more efficient gasification process. In one set of embodiments the packages have a maximum dimension of less than 200 mm, e.g. 100 mm or less. However in other embodiments the packages are larger than this. The size or shape of the pellet may also be chosen so as to be advantageous for packing, transporting or storing the packages.

In a set of embodiments the membrane has a thickness of less than 100 microns, less than 50 microns or for example approximately 25 microns. The membrane is desirably as thin as possible from the point of view of minimising the time taken for a specific reduction in water percentage content to be achieved since the water vapour transfer rate (explained in greater detail below) is dependent on the thickness of the membrane. To counter this however the membrane must have adequate mechanical strength to resist splitting or bursting. Beyond the considerations above however, the Applicant has appreciated that there is a specific advantage in using a membrane which is as thin as possible since it has become aware of a phenomenon whereby the outer surface of the membrane has a tendency to dry out and slow the process of transport of absorbed water molecules across the membrane. When the membrane is thin on the other hand, the proximity of the outer surface to the relatively wetter environment on the inner surface of the membrane reduces this tendency to dry out.

The Applicant believes that the use of thin membranes of such materials is novel and inventive in its own right and thus when viewed from a further aspect the invention provides a method of removing purified water from a material, comprising providing said material on one side of a non-porous hydrophilic membrane, said membrane being of a type in which water molecules are transported across the non-porous hydrophilic membrane to produce said purified water in the other side thereof; wherein the non-porous hydrophilic membrane has a thickness of less than 100 microns, less than 50 microns or less than 30 microns.

The non-porous hydrophilic membranes disclosed herein are from hydrophilic polymers. The term “hydrophilic polymer” means a polymer that absorbs water when in contact with liquid water at room temperature according to International Standards Organization specification ISO 62 (equivalent to the American Society for Testing and Materials specification ASTM D 570). The polymer can also absorb water vapour—which is exploited for example in embodiments involving the dewatering of wood chips or sawdust.

The hydrophilic polymer can be one or a blend of several polymers. For example, the hydrophilic polymer could be a copolyetherester elastomer or a mixture of two or more copolyetherester elastomers, such as polymers available from E.I. du Pont de Nemours & Co. under the name ‘Hytrel’.

Alternatively, the hydrophilic polymer could be polyether-block polyamide or a mixture of two or more polyether-block polyamides, such as the polymers from Elf-Atochem Company of Paris, France available under the name PEBAX. Other hydrophilic polymers include polyether urethanes or a mixture thereof, homopolymers or copolymers of polyvinyl alcohol and mixtures thereof. The above list is not considered to be exhaustive, by merely exemplary of possible choices of hydrophilic membrane.

A particularly preferred polymer for water vapour transmission in this invention is a copolyetherester elastomer or mixture of two or more copolyetherester elastomers having a multiplicity of recurring long-chain ester units and short-chain ester units joined through ester linkages, said long-chain ester units being represented by the formula:

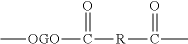

and said short-chain ester units are represented by the formula:

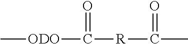

wherein:

a) G is a divalent radical remaining after removal of terminal hydroxyl groups from a poly (alkylene oxide) glycol having a number average molecular weight of about 400-4000;

b) R is a divalent radical remaining after removal of carboxyl groups from a dicarboxylic acid having a molecular weight less than about 300;

c) D is a divalent radical remaining after removal of hydroxyl groups from a diol having a molecular weight less than about 250; optionally

d) the copolyetherester contains 0-68 weight percent, based on the total weight of the copolyetherester, ethylene oxide groups incorporated in the long chain ester units of the copolyetherester;

e) the copolyetherester contains about 25-80 weight percent short-chain ester units.

The preferred polymer film is suitable for fabricating into thin but strong membranes, films and coatings. The preferred polymer, copolyetherester elastomer and methods of making it our known in the art, such as disclosed in U.S. Pat. No. 4,725,481 for a copolyetherester elastomer with a WVTR of 3500 g/m2/24hr, or US Patent No. for a copolyetherester elastomer with a WVTR of 400-2500 g/m2/24hr.

The use of commercially available hydrophilic polymers as membranes is possible in the context of the present invention, although it is clearly preferable to have as high a WVTR as possible. Most preferably, the present invention uses commercially available membranes that yield a WVTR of more than 3500 g/m2/24hr, measured on a film of thickness 25 microns using air at 23′C and 50% relative humidity at a velocity of 3 mus″.

The polymer can be compounded with antioxidant stabilizers, ultraviolet stabilizers, hydrolysis stabilizers, dyes, pigments, fillers, anti-microbial reagents and the like.

A useful and well-established way to make membranes in the form of films is by melt extrusion of the polymer on a commercial extrusion line. Briefly, this entails heating the polymer to a temperature above its melting point and extruding it through a flat or annular die and then casting a film using a roller system or blowing the film from the melt. Useful support materials include woven, non-woven or bonded papers, fabrics and screens and inorganic polymers stable to moisture, such as polyethylene, polypropylene, fibreglass and the like. The support material both increases strength and protects the membrane. The support material may be disposed on only one side of the hydrophilic polymer membrane, or on both sides. When disposed on only one side, the support material can be in contact with the water or away from it.

Without being bound by any particular theory, it is believed that the purifying effect of the hydrophilic membrane, realized either in the form of a coating or an unsupported membrane, when in contact with water that may contain suspended or dissolved impurities, solids and emulsions, occurs because highly dipolar molecules, such as water, are preferentially absorbed and transported across the membrane or coating, compared to ions, such as sodium and chloride. When, in addition, a vapour pressure gradient exists across the membrane, water is released from the side not in contact with the source of water, which released water can be condensed to provide potable water and water for agricultural, horticultural, industrial and other uses.

In relation to the hydrophilic membranes used in the preferred embodiments of the present invention, the water transmission characteristics are generally determined using standard test procedure ASTM E96-95-Procedure BW (previously known and named as test procedure ASTM E96-66-Procedure BW).

These standard test procedures are used to determine the water vapour transmission rate (WVTR) of a membrane, and use an assembly based on a water-impermeable cup (i. e. a “Thwing-Albert Vapometer”). The water-impermeable cup contains water to a level about nineteen millimetres below the top of the cup (specifically, 19 mm 6 mm). The opening of the cup is sealed watertight with a water-permeable membrane of the test material to be measured, leaving an air gap between the water surface and the membrane. In procedure BW, the cup is then inverted so that water is in direct contact with the membrane under test. The apparatus is placed in a test chamber at a controlled temperature and humidity, and air is then blown across the outside of the membrane at a specified velocity. Experiments are run in duplicate.

The weights of the cups, water and membrane assemblies are measured over several days and results are averaged. The rate at which water vapour permeates through the membrane is quoted as the “water transmission vapour rate”, measured as the average weight loss of the assembly at a given membrane thickness, temperature, humidity and air velocity, as expressed as mass loss per unit membrane surface area and time. The WVTR of membranes or films according to ASTM E96-95-Procedure BW is typically measured on a film of thickness twenty five microns and at an air flow rate of three meters per second (3 ms″), air temperature twenty three degrees Celsius (23 C) and fifty percent (50%) relative humidity.

As will be appreciated, in several embodiments of the invention, the contents of the packages are advantageously gasified. The polymer materials discussed herein such as Hytrel, are eminently suited to, and in fact may even enhance, gasification and thus in embodiments of the invention the dewatered material does not need to be removed form the packages for further use, Embodiments of the invention will now be described, by way of example only, with reference to the accompanying drawing which shows an apparatus for manufacturing fuel pouches according to a method embodying the present invention.

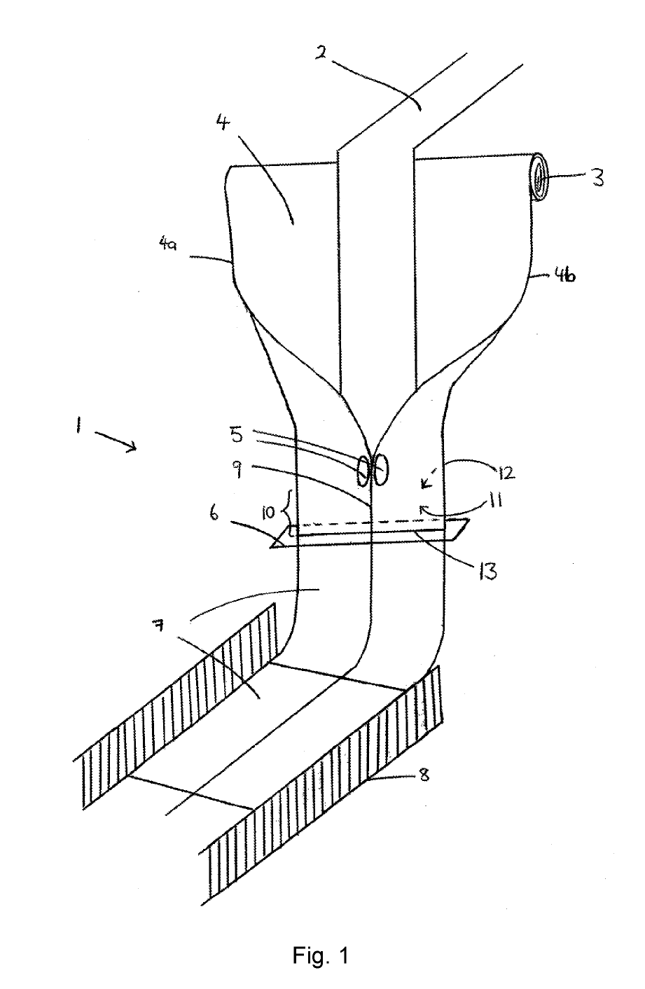

FIG. 1 shows an example embodiment of part of an apparatus 1 for producing fuel pouches.

The apparatus 1 comprises a feed pipe 2 which conveys a stream of animal slurry waste stream. Behind the angled end of the feed pipe 2 is continuous roll 3 of non-porous hydrophilic polymer film 4 such as Hytrel. The film 4 is fed past a pair of heated prods 5 and through a heated slot 6 which causes it to be folded longitudinally around the end of the feed pipe 2. The prods 5 act to heat-seal the two longitudinal edges 4a, 4b of the film to one another along a seam 9 to form a continuous tube whilst the heated slot 6 periodically contracts to clamp the back of the tube 12 to the front 11 in a lateral seal 13 to form a longitudinal series of connected pouches 7.

During this process sewage is supplied through the pipe 2 so that the pouches 7 are each filled with the desired quantity of it. The desired quantity of sewage in each sachet 7 is achieved by setting a flow rate of the waste stream 2 and a drawing speed at which the polymer film 4 is drawn from the roll 3, so that the seal forming the top edge of the pouch 7 is formed when the sewage in the pouch has reached the desired quantity. In other embodiments, the waste stream may be interrupted once the desire quantity in the sachet 7 has been reached, then a seal formed, and then the waste stream recommenced.

Although typically the sewage will have been through a mechanical water extraction process, it starts off relatively wet e.g. with a water content between 55 and 97%.

The filled pouches 7 are removed by a conveyor belt 8 which transports them through a drying chamber (not shown).

As the pouches pass through the drying chamber, the contact of the mixture inside the pouch 7 with the membrane 4 there is a humidity gradient across the membrane which causes the material of the membrane to absorb water molecules and transport them across the membrane until they appear on the outer surface thereof from where they can evaporate. The water content of the contents of the pouches is thus reduced e.g. to less than 10% which makes them suitable for gasification. However different uses may carry different desired water content percentages.

The dehydrated sewage in the pouches 7 is suitable for gasification in a known process to produce syngas which can then be burnt to produce electricity or converted into a liquid fuel. The pouches 7 can be cut to form separate packages or can be left as a connected strip for transportation. The Hytrel membrane does not cause significant amounts of unwanted pollutants in the gasification process; indeed the Hytrel content can aid the gasification process.

It will be appreciated by those skilled in the art that only one possible embodiment has been described and that many variations and modifications are possible within the scope of the invention. For example the pouches could be filled with other material for gasification such as woodchips or sawmill dust. Alternatively they may be used to purify water, dewater foodstuffs etc.

1. A method of dewatering a material comprising:
providing a material having a first water percentage content;
encapsulating the material in a plurality of non-porous hydrophilic membranes, said membranes being of a type in which water molecules are absorbed by and transported across the non-porous hydrophilic membranes, thereby producing packages with a second water percentage content that is lower than the first water percentage content.

2. A method as claimed in claim 1, wherein the membranes are capable of retaining microbes, viruses and bacteria that are present in water whilst purified water is absorbed by and passes across the membranes.

3. A method as claimed in claim 1, wherein the material comprises human or animal waste.

4. A method as claimed in claim 1, further comprising the step of gasifying the packages once the second water percentage content has been achieved.

5. A method as claimed in claim 4, wherein gasification of the packages is used directly to generate electrical power.

6. A method as claimed in claim 4, wherein the step of gasifying the packages comprises producing a synthesised gas suitable for use in the production of a liquid or gaseous fuel.

7. A method as claimed in claim 1 further comprising creating a fuel material from a carbon-based waste material or liquid.

8. A method of removing purified water from a material, comprising providing said material on one side of a non-porous hydrophilic membrane, said membrane being of a type in which water molecules are transported across the non-porous hydrophilic membrane to produce said purified water in the other side thereof; wherein the non-porous hydrophilic membrane has a thickness of less than 100 microns.

9. A method as claimed in claim 8, wherein the non-porous hydrophilic membrane has a thickness of less than 50 microns or less than 30 microns.

10. A method as claimed claim 8 wherein the membrane or membranes comprise(s) a polymer.

11. A method as claimed in claim 10, wherein the polymer is a copolyetherester elastomer or mixture of two or more copolyetherester elastomers having a multiplicity of recurring long-chain ester units and short-chain ester units joined through ester linkages, said long-chain ester units being represented by the formula: 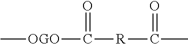
and said short-chain ester units are represented by the formula: 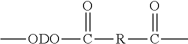
wherein:
a) G is a divalent radical remaining after removal of terminal hydroxyl groups from a poly (alkylene oxide) glycol having a number average molecular weight of about 400-4000;
b) R is a divalent radical remaining after removal of carboxyl groups from a dicarboxylic acid having a molecular weight less than about 300;
c) D is a divalent radical remaining after removal of hydroxyl groups from a diol having a molecular weight less than about 250; optionally
d) the copolyetherester contains 0-68 weight percent, based on the total weight of the copolyetherester, ethylene oxide groups incorporated in the long chain ester units of the copolyetherester;
e) the copolyetherester contains about 25-80 weight percent short-chain ester units.

12. A fuel package comprising a fuel mixture encapsulated in a non-porous hydrophilic membrane.

13. A fuel package as claimed in claim 12, wherein the membranes are capable of retaining microbes, viruses and bacteria that are present in water whilst purified water is absorbed by and passes across the membranes.

14. A fuel package as claimed in claim 12, wherein the material comprises human or animal waste.

15. A fuel package as claimed in claim 12, wherein the material comprises a carbon-based waste material or liquid.

16. A fuel package as claimed in claim 12, wherein the non-porous hydrophilic membrane comprises a polymer.

17. A fuel package as claimed in claim 16, wherein the polymer is a copolyetherester elastomer or mixture of two or more copolyetherester elastomers having a multiplicity of recurring long-chain ester units and short-chain ester units joined through ester linkages, said long-chain ester units being represented by the formula: 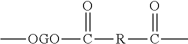
and said short-chain ester units are represented by the formula: 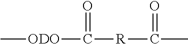
wherein:
a) G is a divalent radical remaining after removal of terminal hydroxyl groups from a poly (alkylene oxide) glycol having a number average molecular weight of about 400-4000;
b) R is a divalent radical remaining after removal of carboxyl groups from a dicarboxylic acid having a molecular weight less than about 300;
c) D is a divalent radical remaining after removal of hydroxyl groups from a diol having a molecular weight less than about 250; optionally
d) the copolyetherester contains 0-68 weight percent, based on the total weight of the copolyetherester, ethylene oxide groups incorporated in the long chain ester units of the copolyetherester;
e) the copolyetherester contains about 25-80 weight percent short-chain ester units.
